(19) United States
(12) Patent Application Publication
(10) Pub. No.: US 2025/0086827 A1
(43) Pub. Date: Mar. 13, 2025

(54) METHOD, DEVICE, AND APPARATUS WITH THREE-DIMENSIONAL IMAGE ORIENTATION

(71) Applicants: SAMSUNG ELECTRONICS CO., LTD., Suwon-si (KR); Korea University Research and Business Foundation, Seoul (KR)

(72) Inventors: Heewon Park, Suwon-si (KR); Nakju DOH, Seoul (KR); Gunhee Koo, Seoul (KR); Joo Hyung KIM, Seoul (KR); Jahoo KOO, Suwon-si (KR)

(73) Assignees: SAMSUNG ELECTRONICS CO., LTD., Suwon-si (KR); Korea University Research and Business Foundation, Seoul (KR)

(21) Appl. No.: 18/810,116

(22) Filed: Aug. 20, 2024

(30) Foreign Application Priority Data
Sep. 13, 2023 (KR) 10-2023-0121891
Nov. 15, 2023 (KR) 10-2023-0158453

(51) Int. Cl. G06T 7/73; G06T 7/536; G06V 20/58; G06V 20/62; G06V 30/18; G06V 30/19

(52) U.S. Cl. CPC G06T 7/73; G06T 7/536; G06V 20/58; G06V 20/63; G06V 30/18181; G06V 30/19127; G06T 2207/20072; G06T 2207/30264

(57) ABSTRACT

A processor-implemented method including detecting pieces of text from an image, determining vanishing points of the image, and estimating an orientation of the image based on the determined vanishing points, the detected pieces of text, and a key text graph representing a connection between nodes corresponding to pieces of key text.

### CROSS-REFERENCE TO RELATED APPLICATIONS

This application claims the benefit under 35 USC § 119 (a) of Korean Patent Application No. 10-2023-0121891, filed on Sep. 13, 2023, and Korean Patent Application No. 10-2023-0158453, filed on Nov. 15, 2023, in the Korean Intellectual Property Office, the entire disclosures of which are incorporated herein by reference for all purposes.

### BACKGROUND

### 1. Field

The following description relates to a method, device, and apparatus with three-dimensional (3D) image orientation.

### 2. Description of Related Art

An indoor parking lot may be a typical space where global positioning system (GPS) information is typically difficult to use. Instead, visual localization may be typically used to locate a three-dimensional (3D) vehicle in an indoor parking lot (i.e., an indoor parking structure). However, because a main feature of an indoor parking lot can be spatial self-similarity (i.e., each level looks the same), this may reduce the performance of visual localization in an indoor parking structure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented including detecting pieces of text from an image, determining vanishing points of the image, and estimating an orientation of the image based on the determined vanishing points, the detected pieces of text, and a key text graph representing a connection between nodes corresponding to pieces of key text.

The estimating of the orientation may include generating, among the nodes of the key text graph, a first matrix based on a first vector between nodes corresponding to the detected pieces of text, generating a second matrix based on a second vector between the detected pieces of text in a camera coordinate system, and calculating the orientation of the image based on the first matrix and the second matrix.

The generating of the first matrix may include determining a vector that is perpendicular to both the first vector and a selected directional vector of plural directional vectors of the key text graph and generating the first matrix using the first vector, the determined vector, and the selected one.

The first vector, the determined vector, and the selected directional vector may correspond to columns of the first matrix, respectively.

The generating of the second matrix may include determining coefficients of directional vectors of the key text graph to configure the first vector with a combination of the directional vectors of the key text graph, determining an order of each of vanishing directional vectors with respect to the determined vanishing points based on the determined coefficients and a vanishing point satisfying a set reference among the determined vanishing points, generating the second vector based on vanishing directional vectors according to the determined order and the determined coefficients, determining a vector perpendicular to the second vector and a selected vanishing vector of the vanishing directional vectors, and generating the second matrix using the second vector, the determined vector, and the selected vanishing vector.

The generated second vector, the determined vector, and the selected vanishing vector may correspond to columns of the second matrix, respectively.

The determining of the order of each of the vanishing directional vectors may include forming a line on the image using the detected pieces of text, finding a vanishing point closest to the formed line among the determined vanishing points, determining an order of vanishing directional vectors with respect to the found vanishing point according to an order of a directional vector having a coefficient with a maximum value among the determined coefficients, and determining an order of each of remaining vanishing directional vectors according to a set reference.

The estimating of the orientation of the image may include generating a rotation matrix with respect to a transformation between a first coordinate system corresponding to the first matrix and a second coordinate system corresponding to the second matrix, using the first matrix and the second matrix and determining the generated rotation matrix to be the orientation of the image.

The method may include generating the key text graph, the generating of the key text graph may include determining the nodes based on pieces of key text obtained from a plurality of images obtained by capturing an inside of a space and a three-dimensional (3D) feature map of the space, connecting each of the determined nodes to one or more adjacent nodes of each of the determined nodes to generate a plurality of edges, classifying the generated plurality of edges into two orthogonal directions to define two dominant directions, and connecting the determined nodes according to the two dominant directions.

The key text graph may include directional vectors, including a first directional vector corresponding to a first of the two orthogonal directions, a second directional vector corresponding to a second of the two orthogonal directions, and a third directional vector perpendicular to the first directional vector and the second directional vector.

In a general aspect, here is provided an electronic device including a processor configured to execute instructions and a memory storing the instructions, and an execution of the instructions causes the processor to detect pieces of text from an image, determine vanishing points of the image, and determine an orientation of the image based on the determined vanishing points, the detected pieces of text, and a key text graph representing a connection between nodes corresponding to pieces of key text.

The execution of the instructions causes the processor to generate, among the nodes of the key text graph, a first matrix based on a first vector between nodes corresponding to the detected pieces of text, generate a second matrix based on a second vector between the detected pieces of text in a camera coordinate system, and determine the orientation of the image based on the first matrix and the second matrix.

The execution of the instructions causes the processor to determine a vector that is perpendicular to both the first vector and a selected directional vector of plural directional vectors of the key text graph and generate the first matrix using the first vector, the determined vector, and the selected directional vector.

The first vector, the determined vector, and the selected directional vector may correspond to columns of the first matrix, respectively.

The execution of the instructions causes the processor to determine coefficients of directional vectors of the key text graph to configure the first vector with a combination of the directional vectors of the key text graph, determine an order of each of vanishing directional vectors with respect to the determined vanishing points based on the determined coefficients and a vanishing point satisfying a set reference among the determined vanishing points, generate the second vector based on vanishing directional vectors according to the determined order and the determined coefficients, determine a vector perpendicular to the second vector and a selected vanishing vector of the vanishing directional vectors, and generate the second matrix using the second vector, the determined vector, and the selected vanishing vector.

The second vector, the determined vector, and the selected vanishing vector may correspond to columns of the second matrix, respectively.

The execution of the instructions causes the processor to form a line on the image using the detected pieces of text, find a vanishing point closest to the formed line among the determined vanishing points, determine an order of vanishing directional vectors with respect to the found vanishing point according to an order of a directional vector having a coefficient with a maximum value among the determined coefficients, and determine an order of each of remaining vanishing directional vectors according to a set reference.

The execution of the instructions causes the processor to generate a rotation matrix with respect to a transformation between a first coordinate system corresponding to the first matrix and a second coordinate system corresponding to the second matrix, using the first matrix and the second matrix and determine the generated rotation matrix to be the orientation of the image.

The execution of the instructions causes the processor to generate the key text graph, the generating including determining the nodes based on pieces of key text obtained from a plurality of images obtained by capturing an inside of a space and a three-dimensional (3D) feature map of the space, connecting each of the determined nodes to one or more adjacent nodes of each of the determined nodes to generate a plurality of edges, classifying the generated plurality of edges into two orthogonal directions to define two dominant directions, and connecting the determined nodes according the two dominant directions.

The key text graph may include directional vectors, including a first directional vector corresponding to a first of the two orthogonal directions, a second directional vector corresponding to a second of the two orthogonal directions, and a third directional vector perpendicular to the first directional vector and the second directional vector.

Other features and aspects will be apparent from the following detailed description, the drawings, and the claims.

### BRIEF DESCRIPTION OF THE DRAWINGS

FIG. 1 illustrates an example electronic system with three-dimensional (3D) orientation estimation according to one or more embodiments.

FIGS. 2 to 4 illustrate examples methods of generating a key text graph according to one or more embodiments.

FIGS. 5 to 10B illustrate examples methods in which an electronic device estimates an orientation (or a direction) of an image according to one or more embodiments.

FIG. 11 illustrates an example electronic device according to one or more embodiments.

FIG. 12 illustrates an example method of generating a key text graph according to one or more embodiments.

FIG. 13 illustrates an example method of estimating an orientation of an image of an electronic device according to one or more embodiments.

FIG. 14 illustrates an example vehicle according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

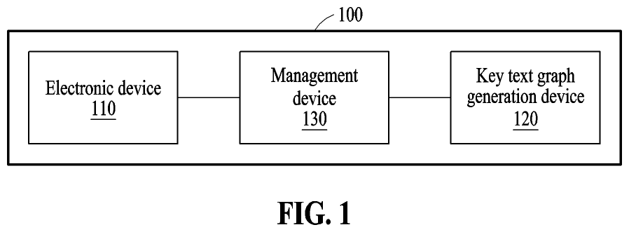

FIG. 1 illustrates an example system with three-dimensional (3D) orientation estimation according to one or more embodiments.

Referring to FIG. 1, in a non-limiting example, the system 100 for estimating a 3D orientation may include one or more of an electronic device 110, a key text graph generation device 120, or a management device 130, or all of the electronic device 110, the key text graph generation device 120, and the management device 130.

A vehicle (e.g., an autonomous vehicle) may include the electronic device 110. In an example, the electronic device 110 may correspond to a part or a component of the vehicle.

The key text graph generation device 120 may be implemented as a server.

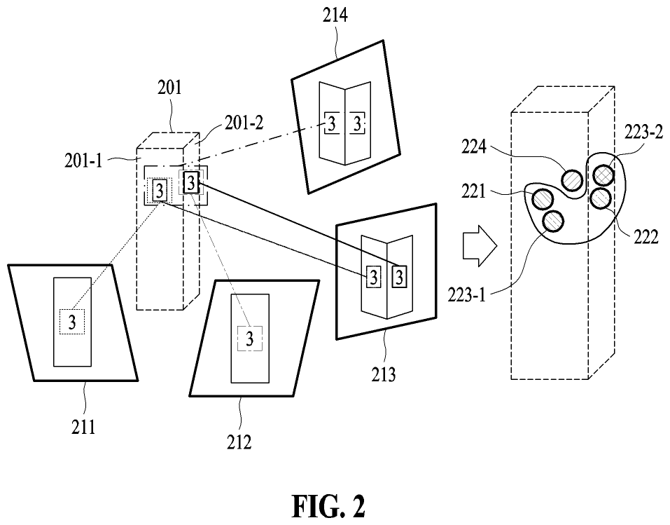

As described in greater detail below with reference to FIGS. 2 to 4, the key text graph generation device 120 may generate (or determine) a key text graph for a space using a 3D feature map and various images for a place (or a space) (e.g., an indoor parking lot, an indoor parking structure, etc.). The key text graph generation device 120 may transmit a place corresponding to the generated key text graph to the management device 130 that manages the place. The management device 130 may be implemented as a server or an access control device but is not limited thereto.

In an example, the electronic device 110 may receive the key text graph from the key text graph generation device 120 and/or the management device 130 and may obtain an image through a camera. The electronic device 110 may detect pieces of text (e.g., pieces of key text) from the obtained image and may determine vanishing points (e.g., vanishing points corresponding to vanishing directional vectors to be described in greater detail below). The electronic device 110 may estimate an orientation (or a direction) of the image (or the camera) based on the key text graph, the vanishing points, and the detected pieces of text. The electronic device 110 may estimate (i.e., calculate or determine) a 3D orientation of the image by associating the determined vanishing points and the detected pieces of text with the key text graph. The electronic device 110 may estimate or calculate the 3D orientation of the image using the key text graph and the image obtained through the camera when the electronic device 110 is in a place (e.g., an indoor parking lot, etc.) where global positioning system (GPS) information is not available. Accordingly, the electronic device 110 may perform further improved visual localization.

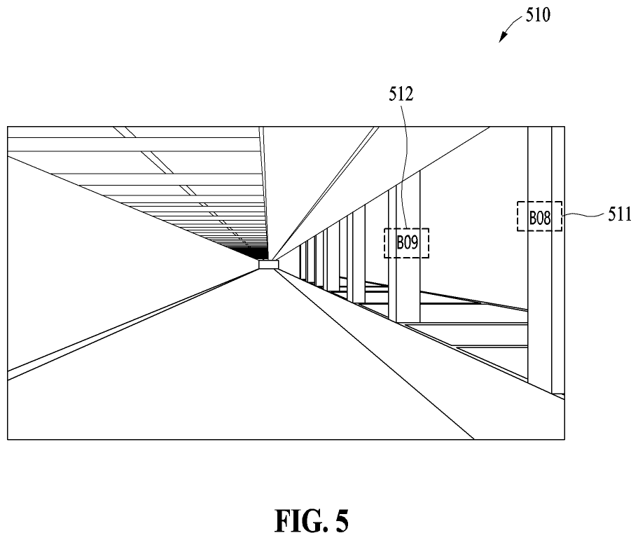

A method of generating a key text graph is described in greater detail below with reference to FIGS. 2 to 4, and a method of estimating a 3D orientation of a given image by the electronic device 110 is described in greater detail below with reference to FIGS. 5 to 10B.

FIGS. 2 to 4 illustrate example methods of generating a key text graph according to one or more embodiments.

Images (hereinafter, referred to as “database (DB) images”) obtained by capturing the inside of a certain space (e.g., an indoor parking lot) may be stored in a DB of the key text graph generation device 120. Each DB image may include one or more pieces of text. Referring to FIG. 2, in a non-limiting example, DB images 211, 212, 213, and 214 obtained by capturing a first pillar 201 inside an indoor parking lot may include a number (e.g., text “3”) of the first pillar 201. DB images obtained by capturing a second pillar inside the indoor parking lot may also include a number of the second pillar.

The key text graph generation device 120 may recognize text “3” in the DB image 211, may recognize text “3” in the DB image 212, and may recognize both text “3” of a first surface 201-1 of the first pillar 201 and text “3” of a second surface 201-2 of the first pillar 201 in the DB image 213. However, in an example, the key text graph generation device 120 may fail to recognize each of text “3” of the first surface 201-1 and text “3” of the second surface 201-2 of the first pillar 201 in the DB image 214 and may recognize text “33.”

In an example, the key text graph generation device 120 may allocate 3D positions for pieces of key text recognized from the DB images 211, 212, 213, and 214, based on a 3D feature map of a certain space (e.g., an indoor parking lot). Accordingly, 3D points 221, 222, 223-1, 223-2, and 224 may be represented as illustrated in FIG. 2. The key text graph generation device 120 may generate the 3D points 221, 222, 223-1, 223-2, and 224 by projecting bounding boxes and the pieces of key text recognized from the DB images 211, 212, 213, and 214 into a 3D space. The 3D point 221 may be generated by projecting the bounding box and the text “3” recognized in the DB image 211 into the 3D space, and the 3D point 222 may be generated by projecting the bounding box and the text “3” recognized in the DB image 212 into the 3D space. The 3D point 223-1 may be generated by projecting the bounding box and the text “3” of the first surface 201-1 recognized in the DB image 213 into the 3D space, and the 3D point 223-2 may be generated by projecting the bounding box and the text “3” of the second surface 201-2 recognized in the DB image 213 into the 3D space. The 3D point 224 may be generated by projecting the bounding box and the text “33” recognized in the DB image 214 into the 3D space.

The key text graph generation device 120 may perform clustering on the 3D points 221, 222, 223-1, 223-2, and 224 to filter the incorrectly recognized key text (e.g., the text “33”). Accordingly, the key text graph generation device 120 may filter (or exclude) the 3D point 224.

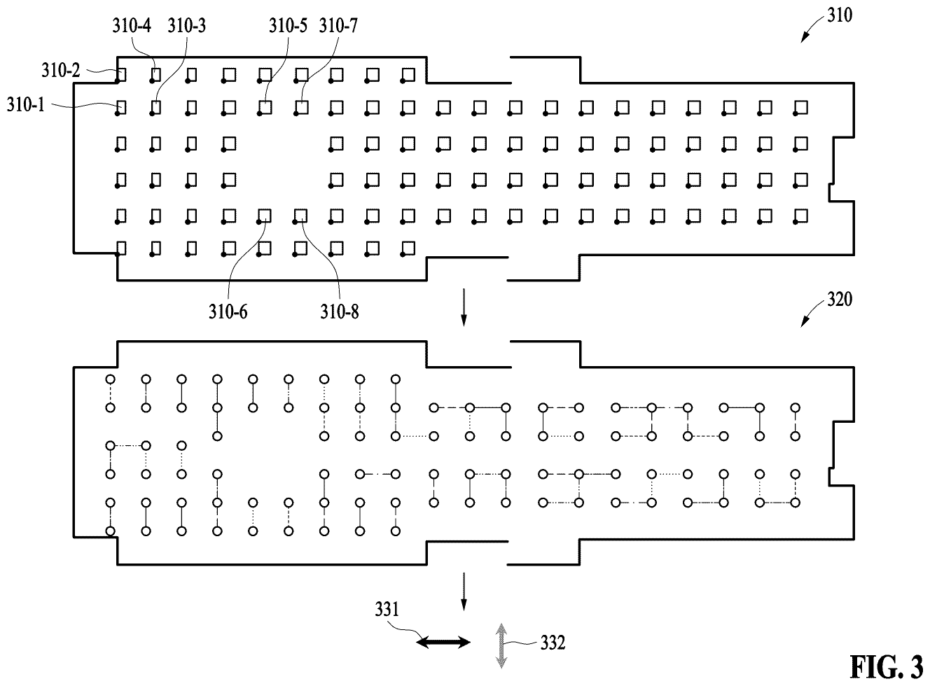

The key text graph generation device 120 may define (or determine) a node (or a position of a node) corresponding to the key text “3” based on the clustering result (e.g., the 3D points 221, 222, 223-1, and 223-2) of the 3D points 221, 222, 223-1, 223-2, and 224. In an example, the key text graph generation device 120 may determine an average value of the 3D points 221, 222, 223-1, and 223-2 to be the position of the node corresponding to the key text “3.” Similarly, the key text graph generation device 120 may define a node (or a position of a node) corresponding to each of the remaining pieces of key text in a certain space (e.g., an indoor parking lot). Referring to FIG. 3, in a non-limiting example, the key text graph generation device 120 may generate (or determine) a set 310 of nodes corresponding to the pieces of key text. In the example shown in FIG. 3, a node 310-1 may be, for example, a node corresponding to the key text “3.”

The key text graph generation device 120 may determine the set 310 of nodes corresponding to pieces of key text (e.g., a column number of an indoor parking lot) of a certain space, based on a 3D feature map of a certain space (e.g., an indoor parking lot) and DB images.

In an example, the key text graph generation device 120 may generate a set 320 of edges by connecting each of the nodes in the set 310 to one or more adjacent nodes of each of the nodes in the set 310. For example, the node 310-1 may be closest to a node 310-2 and a node 310-3 may be closest to a node 310-4. The key text graph generation device 120 may generate an edge by connecting the node 310-1 to the node 310-2 and may generate an edge by connecting the node 310-3 to the node 310-4.

The key text graph generation device 120 may define two dominant directions by classifying the edges in the set 320 into two orthogonal directions. For example, the key text graph generation device 120 may define direction 331 (e.g., an x-axis direction) and direction 332 (e.g., a y-axis direction) by classifying the edges in the set 320 into two orthogonal directions. The direction 331 and the direction 332 may be orthogonal to each other.

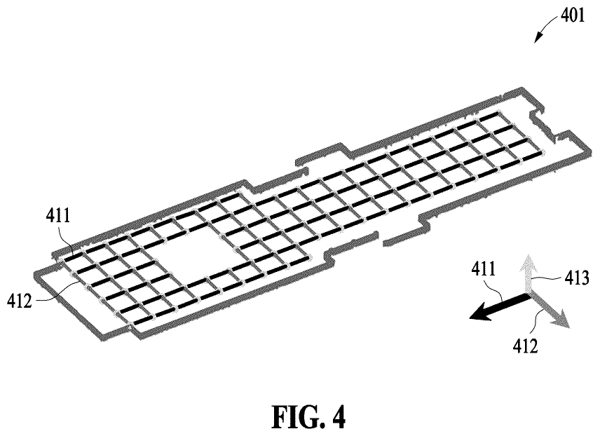

According to the direction 331 and the direction 332, the key text graph generation device 120 may generate a key text graph by connecting the nodes in the set 310. In an example, the key text graph generation device 120 may not connect two nodes when a distance between the two nodes is greater than or equal to a predetermined distance. Referring to FIG. 4, in a non-limiting example, a key text graph 401 is illustrated. In the set 320 of edges of FIG. 3, the node 310-1 and the node 310-3 may not be connected to each other and the node 310-2 and the node 310-4 may not be connected to each other. Referring back to FIG. 4, according to the direction 331, the key text graph generation device 120 may connect the node 310-1 to the node 310-3 and may connect the node 310-2 to the node 310-4.

Referring to FIG. 3, a structure may exist between a node 310-5 and a node 310-6 in the set 320, or a distance between the node 310-5 and the node 310-6 may be greater than or equal to a predetermined distance. Likewise, a structure may exist between a node 310-7 and a node 310-8 in the set 320 (i.e., an obstruction), or a distance between the node 310-7 and the node 310-8 may be greater than or equal to a predetermined distance (i.e., a large distance). As a result of the respective obstructions and/or large distances, the key text graph generation device 120 may not connect the node 310-5 to the node 310-6 and may not connect the node 310-7 to the node 310-8.

The key text graph generation device 120 may determine a directional vector corresponding to the direction 331 (hereinafter, referred to as a “first directional vector”) and may determine a directional vector corresponding to the direction 332 (hereinafter, referred to as a “second directional vector”). The key text graph generation device 120 may determine a directional vector that is orthogonal to both the first directional vector and the second directional vector (hereinafter, referred to as a “third directional vector”). FIG. 4 illustrates an example of each of a first directional vector 411, a second directional vector 412, and a third directional vector 413. The first directional vector 411 may represent a directional vector (or a base vector) of a +x-axis, the second directional vector 412 may represent a directional vector (or a base vector) of a +y-axis, and the third directional vector 413 may represent a directional vector (or a base vector) of a +z-axis.

The key text graph generation device 120 may transmit, for example, the key text graph 401 to the management device 130. When a vehicle including the electronic device 110 enters a place (e.g., an indoor parking lot) managed by the management device 130, the electronic device 110 may receive the key text graph 401 from the management device 130 (or the key text graph generation device 120).

FIGS. 5 to 10B illustrate example methods in which an electronic device estimates an orientation (or a direction) of an image according to one or more embodiments.

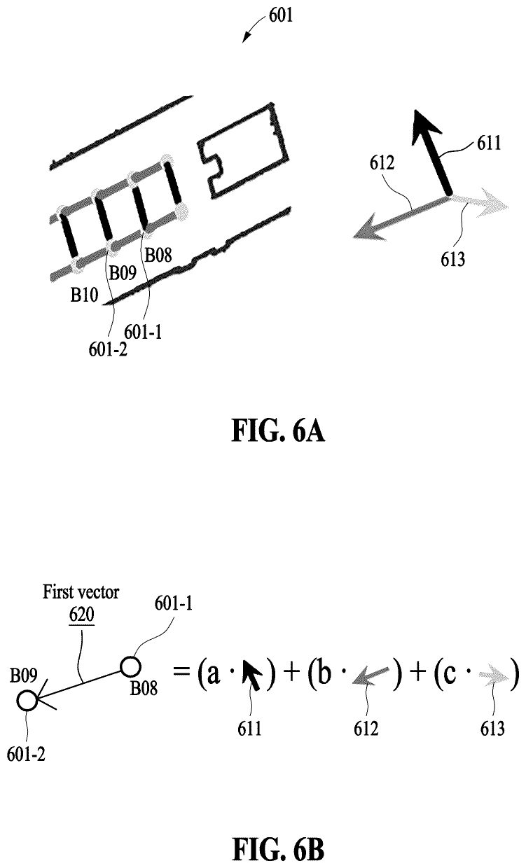

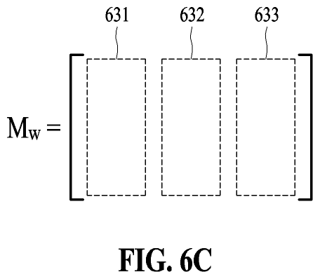

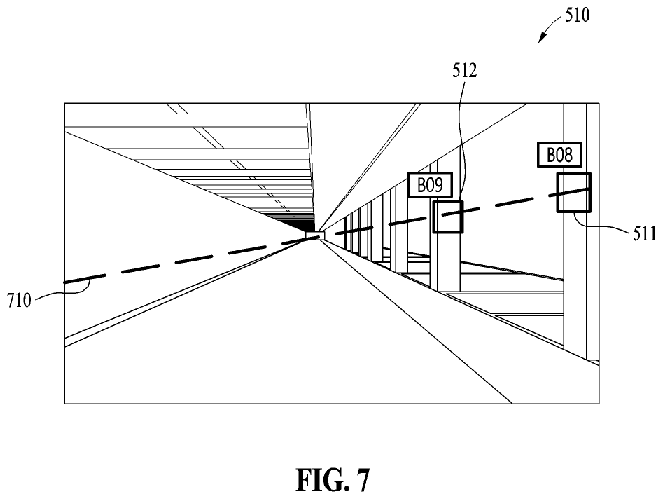

In an example, the electronic device 110 may determine, among nodes of a key text graph, a first matrix M_{w} based on a first vector between nodes corresponding to pieces of text (e.g., two selected pieces of key text) detected from an image. In a camera coordinate system, the electronic device 110 may determine a second matrix M_{q} based on a second vector between detected pieces of text (e.g., two selected pieces of key text). The electronic device 110 may estimate an orientation (or a direction) of an image based on the determined first matrix M_{w} and the determined second matrix M_{q}. Hereinafter, a method of determining the first matrix M_{w} is described with reference to FIGS. 5 to 6C and a method of determining the second matrix M_{q} is described with reference to FIGS. 7 to 10B.

Referring FIG. 5, in a non-limiting example, an image 510 may be obtained by capturing an indoor parking lot by a front camera of a vehicle.

In an example, the electronic device 110 may detect (or obtain) pieces of text (e.g., pieces of key text) from the image 510 obtained through a camera (e.g., the front camera of the vehicle). For example, the electronic device 110 may recognize pieces of text (e.g., B08, B09, B10, etc.) in the image 510. The electronic device 110 may select text 511 (e.g., B08), which is the largest and most clear text, and text 512 (e.g., B09), which is adjacent (or closest) to the text 511, in the image 510.

The electronic device 110 may receive a key text graph for a space (e.g., an indoor parking lot) where the electronic device 110 is positioned from the management device 130 and/or the key text graph generation device 120. Referring to FIG. 6A, in a non-limiting example, a portion of the key text graph for a space (e.g., the indoor parking lot) where the electronic device 110 is positioned is illustrated.

In the example shown in FIG. 6A, a node 601-1 corresponding to the text 511 and a node 601-2 corresponding to the text 512 may be defined in a portion of a key text graph 601. First to third directional vectors 611, 612, and 613 may exist in the key text graph 601. The first to third directional vectors 611, 612, and 613 may be directional vectors in a first coordinate system (e.g., a map coordinate system). The first directional vector 611 (e.g., the first directional vector 411 of FIG. 4) may represent a directional vector of a +x-axis, the second directional vector 612 (e.g., the second directional vector 412 of FIG. 4) may represent a directional vector of a +y-axis, and the third directional vector 613 (e.g., the third directional vector 413 of FIG. 4) may represent a directional vector of a +z-axis. An opposite directional vector of the first directional vector 611 may represent a directional vector of a-x-axis, an opposite directional vector of the second directional vector 612 may represent a directional vector of a-y-axis, and an opposite directional vector of the third directional vector 613 may represent a directional vector of a-z-axis.

The first to third directional vectors 611, 612, and 613 may be orthogonal to each other. For example, the first directional vector 611 may be orthogonal to the second directional vector 612, the second directional vector 612 may be orthogonal to the third directional vector 613, and the third directional vector 613 may be orthogonal to the first directional vector 611.

The electronic device 110 may configure (or determine) a vector between the node 601-1 corresponding to the text 511 and the node 601-2 corresponding to the text 512. That is, the electronic device 110 may configure (or determine) a vector between the text 511 and the text 512 on the first coordinate system (e.g., the map coordinate system). Because, in an example, the electronic device 110 may recognize that the size of the text 511 is larger than the size of the text 512, the electronic device 110 may configure (or determine) a vector 620 (hereinafter, referred to as a “first vector” 620) from the node 601-1 toward the node 601-2. Unlike the example shown in FIG. 5, when the size of text “B09” is larger than the size of text “B08” in the image, the electronic device 110 may configure a vector from the node 601-2 toward the node 601-1.

The electronic device 110 may configure (or determine) the first vector 620 with a combination (e.g., a linear combination) of the first to third directional vectors 611, 612, and 613. Referring to FIG. 6B, in a non-limiting example, the electronic device 110 may configure the first vector 620 as “a·the first directional vector 611+b·the second directional vector 612+c·the third directional vector 613.” Here, each of a, b, and c may represent a coefficient (or a linear coefficient).

In the examples shown in FIGS. 6A and 6B, the first vector 620 may be the same as the second directional vector 612. That is, the magnitude and direction of the first vector 620 may be the same as the magnitude and direction of the second directional vector 612. In this case, the electronic device 110 may determine a to be 0, b to be 1, and c to be 0. Unlike the examples shown in FIGS. 6A and 6B, the first vector 620 may have, as components, a portion of the first directional vector 611, a portion of the second directional vector 612, and a portion of the third directional vector 613. In this case, each of a, b, and c may not be determined to be 0. In another example, the first vector 620 may have a portion of the first directional vector 611 and a portion of the second directional vector 612 as components and may not have a portion of the third directional vector 613 as a component. In this case, c may be determined to be 0 and a and b may not be determined to be 0.

The electronic device 110 may determine the first matrix M_{w} based on the first vector 620. The first matrix M_{w} may represent, for example, a directional matrix representing three different directions from key text (e.g., the text 511) (or the node 601-1) in the first coordinate system (e.g., the map coordinate system). Referring to FIG. 6C, in a non-limiting example, the electronic device 110 may determine the first vector 620 to be a first column 631 of the first matrix M_{w}, may determine the third directional vector 613 to be a third column 633 of the first matrix M_{w}, and may determine a cross product operation result (e.g., the third directional vector 613×the first vector 620) of the first vector 620 and the third directional vector 613 to be a second column 632 of the first matrix M_{w}. Here, the symbol “x” may represent a cross product operation.

Hereinafter, a method of determining the second matrix M_{q} is described with reference to FIGS. 7 to 10B.

The electronic device 110 may form a line in the image 510 using the text 511 and the text 512. Referring to FIG. 7, in a non-limiting example, the electronic device 110 may form a line 710 passing through the text 511 and the text 512 on the image 510.

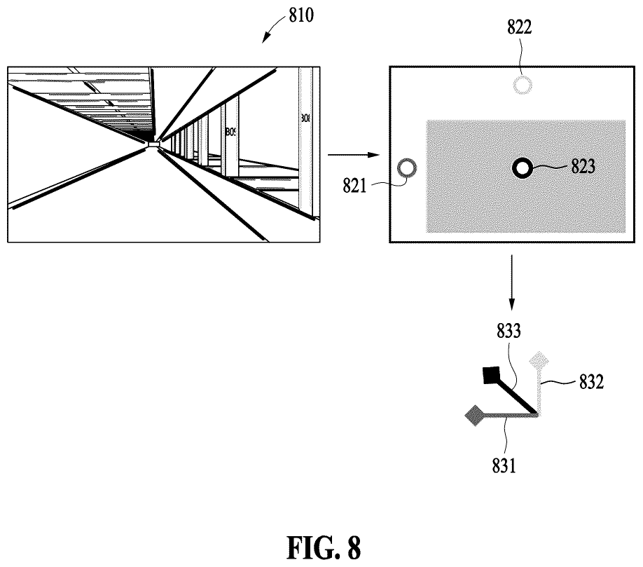

The electronic device 110 may detect line segments by performing line segment detection on the image 510. Referring to FIG. 8, in a non-limiting example, a result 810 of the line segment detection is illustrated. In the example shown in FIG. 8, the electronic device 110 may classify the detected line segments into first to third groups by clustering the line segments detected from the image 510. The first group may include line segments having a first direction (e.g., a horizontal direction) in the image 510, the second group may include line segments having a second direction (e.g., a vertical direction), and the third group may include, for example, line segments having a third direction (e.g., a direction that is orthogonal to both the first direction and the second direction).

In an example, the electronic device 110 may determine (or estimate) vanishing points 821, 822, and 823 of the image 510 through the first to third groups. For example, the electronic device 110 may determine the vanishing point 821 for the line segments of the first group through the first group, may determine the vanishing point 822 for the line segments of the second group through the second group, may determine the vanishing point 823 for the line segments of the third group through the third group.

The electronic device 110 may determine (or estimate) first to third vanishing directional vectors 831, 832, and 833 with respect to the vanishing points 821, 822, and 823 based on the vanishing points 821, 822, and 823. The first vanishing directional vector 831 may represent, for example, a directional vector with respect to the vanishing point 821 in a second coordinate system (e.g., a camera coordinate system) having a camera as the origin. The second vanishing directional vector 832 may represent, for example, a directional vector with respect to the vanishing point 822 in the second coordinate system (e.g., the camera coordinate system) and the third vanishing directional vector 833 may represent, for example, a directional vector with respect to the vanishing point 823 in the second coordinate system (e.g., the camera coordinate system).

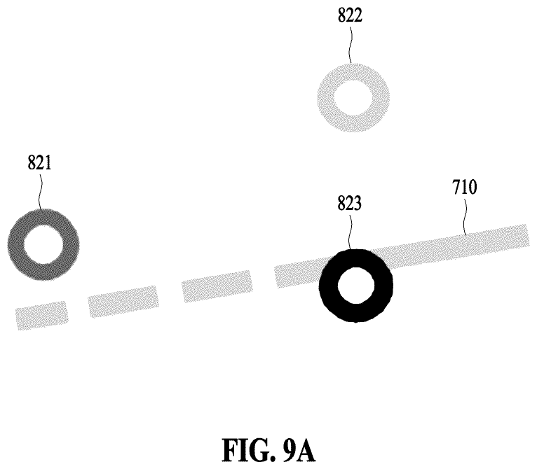

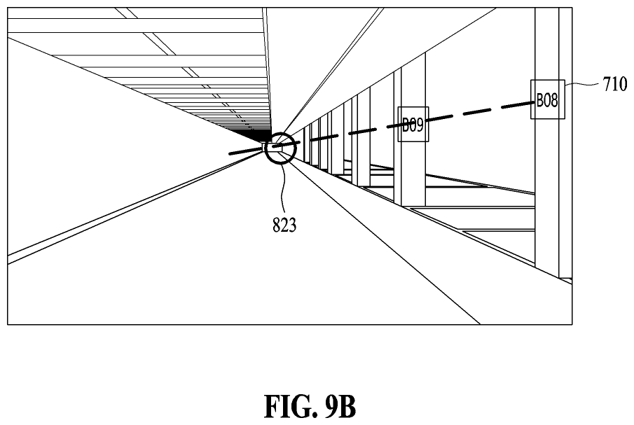

The electronic device 110 may calculate (or determine) a distance between the line 710 of FIG. 7 and each of the vanishing points 821, 822, and 823 on the image 510. The electronic device 110 may find a vanishing point that is closest to the line 710 among the vanishing points 821, 822, and 823. Referring to FIGS. 9A and 9B, in a non-limiting example, the electronic device 110 may determine that the vanishing point 823 is closest to the line 710 among the vanishing points 821, 822, and 823.

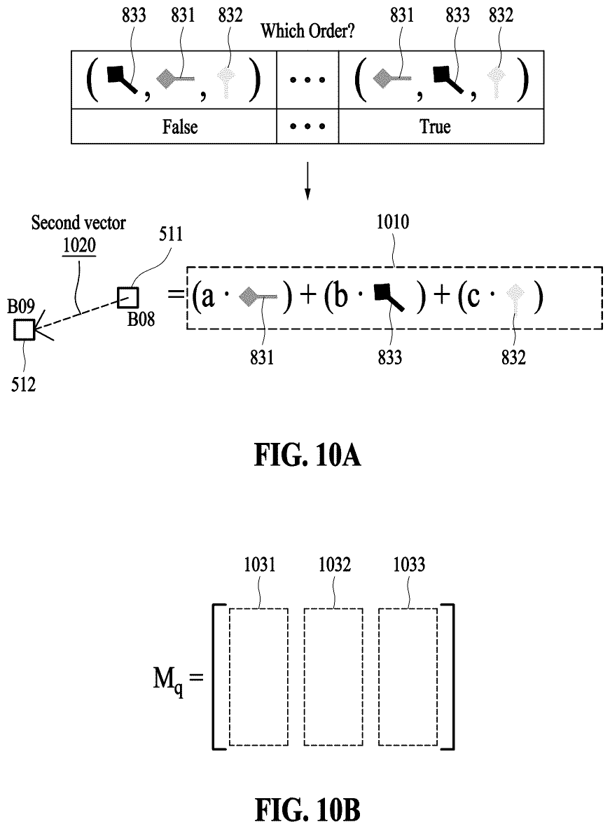

The electronic device 110 may determine (or allocate) the order of each of the first to third vanishing directional vectors 831, 832, and 833 based on the vanishing point 823 that is closest to the line 710 and the coefficients a, b, and c of the first to third directional vectors 611, 612, and 613. For example, among the coefficients a, b, and c, the coefficient a may be a first order, the coefficient b may be a second order, and the coefficient c may be a third order. Accordingly, the first directional vector 611 may have the first order, the second directional vector 612 may have the second order, and the third directional vector 613 may have the third order. In the example described above, the coefficient a may be, for example, 0, the coefficient b may be, for example, 1, and the coefficient c may be, for example, 0. The electronic device 110 may determine the order of the third vanishing directional vector 833 with respect to the vanishing point 823 that is closest to the line 710 according to the order of the second directional vector 612 having the coefficient b with the maximum value among the coefficients a, b, and c. The electronic device 110 may determine the order of a directional vector (e.g., the second directional vector 612) of the most dominant direction of the first vector 620 to be the order of the third vanishing directional vector 833 with respect to the vanishing point 823 that is closest to the line 710. Referring to FIG. 10A, in a non-limiting example, because the second directional vector 612 may have the second order, the electronic device 110 may determine the order of the third vanishing directional vector 833 to be the second order. The order of the second vanishing directional vector 832 may be fixed (or predetermined) as the third order (or the last order). Since the first order is empty, the electronic device 110 may determine the order of the first vanishing directional vector 831 to be the first order.

The electronic device 110 may configure a vector 1020 (hereinafter, referred to as a second vector 1020) from the text 511 toward the text 512, using the order of each of the first to third vanishing directional vectors 831, 832, and 833 and the coefficients a, b, and c. For example, the electronic device 110 may apply the coefficient a to the first vanishing directional vector 831 because the order of the first vanishing directional vector 831 is the first order. Since the order of the third vanishing directional vector 833 is the second order, the electronic device 110 may apply the coefficient b to the third vanishing directional vector 833. Since the order of the second vanishing directional vector 832 is the last order, the electronic device 110 may apply the coefficient c to the second vanishing directional vector 832. The electronic device 110 may configure the second vector 1020 by applying each of the coefficients a, b, and c to the first to third vanishing directional vectors 831, 832, and 833 according to the order of each of the first to third vanishing directional vectors 831, 832, and 833. The electronic device 110 may configure the second vector 1020 as a set 1010 of “a·the first vanishing directional vector 831+b·the third vanishing directional vector 833+c·the second directional vector 832.”

The electronic device 110 may determine the second matrix M_{q} based on the second vector 1020. The second matrix M_{q} may represent, for example, a directional matrix representing three different directions from key text (e.g., the text 511) in the second coordinate system (e.g., the camera coordinate system). Referring to FIG. 10B, in a non-limiting example, the electronic device 110 may determine the second vector 1020 to be a first column 1031 of the second matrix M_{q}, may determine the second vanishing directional vector 832 to be a third column 1033 of the second matrix M_{q}, and may determine a cross product operation result (e.g., the second vanishing directional vector 832× the second vector 1020) of the second vector 1020 and the second vanishing directional vector 832 to be a second column 1032. Here, the symbol “x” may represent a cross product operation.

The electronic device 110 may estimate (or determine) the orientation (or the direction) of the image 510 based on the first matrix M_{w} and the second matrix M_{q}. In an example, the electronic device 110 may determine a rotation matrix R_{q}_{ₑₛₜ}^{w} through Equation 1 below.

### Equation 1:

$${R}_{{q}_{est}}^{w} = {M}_{w} \cdot {( {M}_{q} )}^{- 1} .$$

The electronic device 110 may estimate (or determine) the orientation (e.g., a 3D orientation) (or a 3D direction of a camera) of the image 510 according to the determined rotation matrix R*_{q}_{ₑₓₜ}^{w}. The electronic device 110 may determine the rotation matrix R_{q}_{ₑₛₜ}^{w} corresponding to a relative transformation (e.g., a rotation transformation) between the first coordinate system (e.g., the map coordinate system) and the second coordinate system (e.g., the camera coordinate system), using the first matrix M_{w} and the second matrix M_{q}. The electronic device 110 may estimate (or determine) the rotation matrix R_{q}_{ₑₛₜ}^{w} as the 3D orientation (or the 3D direction) of the image 510.

When the electronic device 110 is in a space (e.g., an indoor parking lot, etc.) where GPS information is not available, the electronic device 110 may determine (or estimate) the 3D orientation of the image 510 (or a camera) using the image 510 obtained through the camera and the key text graph. Accordingly, the electronic device 110 may achieve a more accurate and improved visual localization.

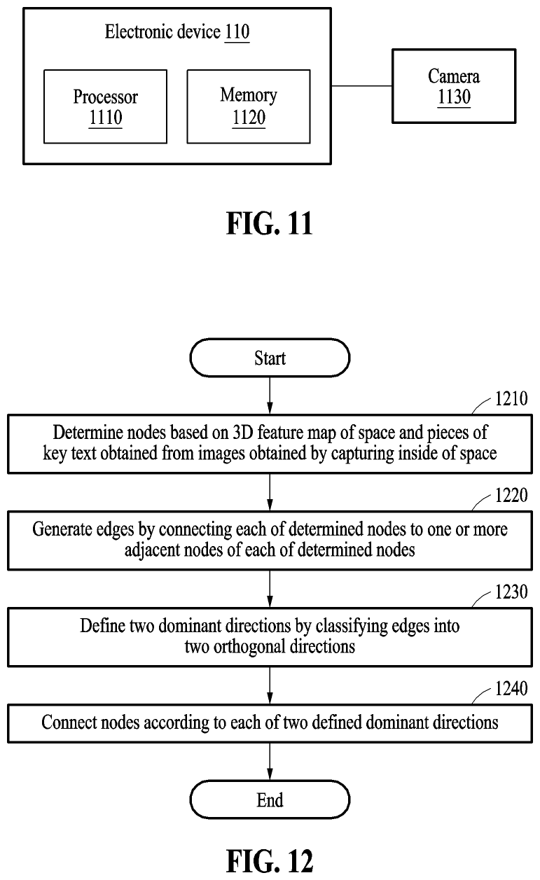

FIG. 11 illustrates an example electronic device according to one or more embodiments.

Referring to FIG. 11, in a non-limiting example, the electronic device 110 may include a processor 1110 and a memory 1120.

The memory 1120 may include computer-readable instructions. The processor 1100 may be configured to execute computer-readable instructions, such as those stored in the memory 1120, and execution of the computer-readable instructions causes the processor 1100 to perform one or more, or any combination, of the operations and/or methods described herein. The memory 1120 may be a volatile or nonvolatile memory. The processor 1110 may be configured to execute programs or applications to cause (or configure) the processor 1110 to control the electronic device 1100 to perform one or more or all operations and/or methods involving the reconstruction of images, and may include any one or a combination of two or more of, for example, a central processing unit (CPU), a graphic processing unit (GPU), a neural processing unit (NPU) and tensor processing units (TPUs), but is not limited to the above-described examples.

In an example, the processor 1110 may receive the image 510 from a camera 1130. Although FIG. 11 illustrates the camera 1130 as being outside of the electronic device 110, this is only an example, and the camera 1130 may correspond to a component of the electronic device 110.

In an example, the processor 1110 may detect pieces of text (e.g., the text 511, the text 512, etc.) from the image 510 obtained through the camera 1130.

In an example, the processor 1110 may determine the vanishing points 821, 822, and 823 of the obtained image 510.

In an example, the processor 1110 may estimate the orientation (e.g., the 3D orientation) (or the direction) of the image 510 based on the key text graph 601 representing a connection between nodes corresponding to pieces of key text, the determined vanishing points 821, 822, and 823, the detected text 511, and the detected text 512.

In an example, the processor 1110 may determine, among nodes of the key text graph 601, the first matrix M_{w} based on the first vector 620 between the node 601-1 and the node 601-2 corresponding to the detected text 511 and the detected text 512, respectively. For example, the processor 1110 may determine a vector (e.g., the third directional vector 613×the first vector 620) that is perpendicular to both the first vector 620 and a selected one (e.g., the third directional vector 613) of the first to third directional vectors 611, 612, and 613 of the key text graph 601. Here, the symbol “x” may represent a cross product operation. The processor 1110 may determine the first matrix M_{w} using the first vector 620, the determined vector (e.g., the third directional vector 613×the first vector 620), and the selected one (e.g., the third directional vector 613). Here, the first vector 620, the determined vector (e.g., the third directional vector 613×the first vector 620), and the selected one (e.g., the third directional vector 613) may correspond to columns of the first matrix M_{w}, respectively.

In an example, the processor 1110 may determine the second matrix M_{q} based on the second vector 1020 between the detected text 511 and the detected text 512. For example, the processor 1110 may determine coefficients (e.g., a, b, and c) of the first to third directional vectors 611, 612, and 613 such that the first vector 620 is configured with a combination of the first to third directional vectors 611, 612, and 613 of the key text graph 601. The processor 1110 may determine, among the vanishing points 821, 822, and 823, the order of each of the first to third vanishing directional vectors 831, 832, and 833 with respect to the vanishing points 821, 822, and 823 based on a vanishing point (e.g., the vanishing point 823 that is closest to the line 710), which satisfies a set reference, and the determined coefficients (e.g., a, b, and c). The processor 1110 may determine the second vector 1020 based on the first to third vanishing directional vectors 831, 832, and 833 according to the determined order and the determined coefficients (e.g., a, b, and c). The processor 1110 may determine a vector (e.g., the second vanishing directional vector 832× the second vector 1020) that is perpendicular to both the second vector 1020 and a selected one (e.g., the second vanishing directional vector 832) of the first to third vanishing directional vectors 831, 832, and 833. The processor 1110 may determine the second matrix M_{q} using the second vector 1020, the determined vector (e.g., the second vanishing directional vector 832× the second vector 1020), and the selected one (e.g., the second vanishing directional vector 832). The second vector 1020, the determined vector (e.g., the second vanishing directional vector 832×the second vector 1020), and the selected one (e.g., the second vanishing directional vector 832) may correspond to columns of the second matrix M_{q}, respectively.

In an example, the processor 1110 may form the line 710 on the image 510 using the detected text 511 and the detected text 512. The processor 1110 may find the vanishing point 823 that is closest to the line 710 among the determined vanishing points 821, 822, and 823. The processor 1110 may determine the order of a vanishing directional vector (e.g., the third vanishing directional vector 833) with respect to the vanishing point 823 found above according to the order of a directional vector (e.g., the second vanishing directional vector 612) having a coefficient (e.g., b) with the maximum value among the determined coefficients (e.g., a, b, and c). The processor 1110 may determine the order of each of the remaining vanishing directional vectors according to a set reference. For example, the order of the third vanishing directional vector 833 may be determined to be the second order. The order of the second vanishing directional vector 832 may be fixed as the last order (or the third order) or may be predetermined. The processor 1110 may determine the order of the first vanishing directional vector 831 to be the first order.

In an example, the processor 1110 may estimate the orientation of the image 510 based on the determined first matrix M_{w} and the determined second matrix M_{q}. For example, the processor 1110 may determine the rotation matrix R_{q}_{ₑₛₜ}^{w} with respect to a transformation between the first coordinate system (e.g., the map coordinate system) corresponding to the first matrix M_{w} and the second coordinate system (e.g., the camera coordinate system) corresponding to the second matrix M_{q}, using the first matrix M_{w} and the second matrix M_{q}. The processor 1110 may determine the rotation matrix R_{q}_{ₑₛₜ}^{w} according to Equation 1 described above. The processor 1110 may determine the determined rotation matrix R_{q}_{ₑₛₜ}^{w} to be the orientation (e.g., the 3D orientation) of the image 510.

The operations of the electronic device 110 described above with reference to FIGS. 1 to 10 may apply to the electronic device 110 described with reference to FIG. 11.

FIG. 12 illustrates an example method of generating a key text graph according to one or more embodiments.

The method of generating the key text graph to be described with reference to FIG. 12 may be performed by a key text graph generation device (e.g., key text graph generation device 120 or the electronic device 110).

Referring to FIG. 12, in a non-limiting example, the key text graph generation device (e.g., key text graph generation device 120) may determine nodes (e.g., the set 310 of nodes of FIG. 3) based on a 3D feature map of the space and pieces of key text obtained from a plurality of images obtained by capturing the inside of a space (or a place) (e.g., an indoor parking lot, etc.) in operation 1210.

In operation 1220, the key text graph generation device (e.g., key text graph generation device 120) may generate a plurality of edges (e.g., the set 320 of edges of FIG. 3) by connecting each of the determined nodes to one or more adjacent nodes of each of the determined nodes.

In operation 1230, the key text graph generation device (e.g., key text graph generation device 120) may define two dominant directions (e.g., direction 331 and direction 332) by classifying the edges into two orthogonal directions.

In operation 1240, the key text graph generation device (e.g., key text graph generation device 120) may connect the nodes according to each of the two defined dominant directions (e.g., direction 331 and direction 332). Through this connection, the key text graph generation device (e.g., key text graph generation device 120) may generate a key text graph (e.g., key text graph 401).

In an example, the first to third directional vectors 411, 412, and 413 of the key text graph 401 may include the first directional vector 411 corresponding to the dominant direction 331 of the two dominant directions (e.g., direction 331 and direction 332), the second directional vector 412 corresponding to the dominant direction 332 of the two dominant directions (e.g., direction 331 and direction 332), and the third directional vector 413 that is perpendicular to both the first directional vector 411 and the second directional vector 412.

The operations of the key text graph generation device 120 described above with reference to FIGS. 1 to 4 may apply to the key text graph generation method described with reference to FIG. 12.

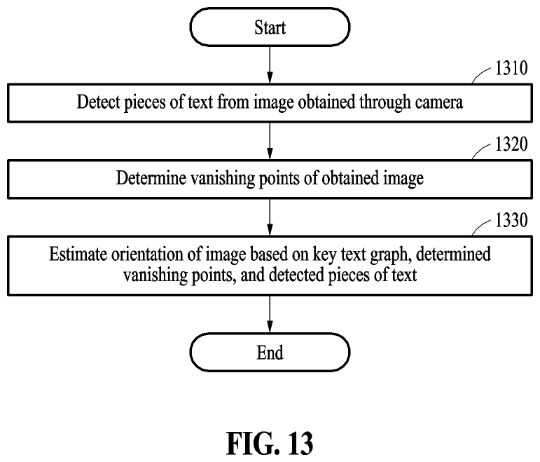

FIG. 13 illustrates an example method of estimating an orientation of an image of an electronic device according to one or more embodiments.

Referring to FIG. 13, in a non-limiting example, an electronic device (e.g., electronic device 110) may detect pieces of text from an image (e.g., image 510) obtained through an imaging device (e.g., the camera 1130).

In operation 1320, the electronic device (e.g., electronic device 110) may determine vanishing points (e.g., vanishing points 821, 822, and 823 of the obtained image 510) of the obtained image.

In operation 1330, the electronic device (e.g., electronic device 110) may estimate the orientation of the image (e.g., image 510) based on the key text graph (e.g., key text graph 601), the determined vanishing points (e.g., the vanishing points 821, 822, and 823), and the detected pieces of text.

The operations of the electronic device 110 described above with reference to FIGS. 1 to 10 may apply to the image orientation estimation method described with reference to FIG. 13.

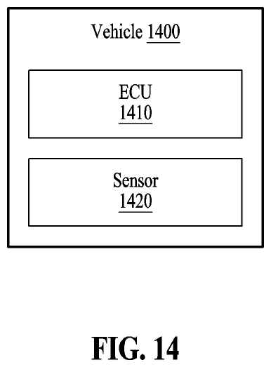

FIG. 14 illustrates an example vehicle according to one or more embodiments.

Referring to FIG. 14, in a non-limiting example, a vehicle 1400 (e.g., an autonomous vehicle) may include an electronic control unit (ECU) 1410 and a sensor 1420.

The ECU 1410 may include the electronic device 110 described above. That is, the ECU 1410 may perform the operation of the electronic device 110. However, examples are not limited thereto, and the electronic device 110 may be separated from the ECU 1410.

In an example, the ECU 1410 may control the operation of the vehicle 1400. For example, the ECU 1410 may change and/or adjust at least one of the speed, acceleration, or steering of the vehicle 1400. The ECU 1410 may operate a brake to decelerate the vehicle 1400 and may control a steering angle of the vehicle 1400.

In an example, the sensor 1420 may generate sensing data by receiving signals (e.g., visible light, radar signals, light, ultrasonic waves, or infrared waves). For example, the sensor 1420 may include a camera, a radar sensor, a LiDAR sensor, an ultrasonic sensor, or an infrared sensor.

The ECU 1410 may estimate a 3D orientation (or a direction) of an image (or a camera) using the key text graph 601 and an image received from the camera and may determine the estimated 3D orientation (or the direction) to be a 3D orientation (or a direction) of the vehicle 1400. The 3D orientation (or the direction) of the vehicle 1400 may be important base information for estimating, for example, the 6 degrees of freedom (DoF) pose of the vehicle 1400.

The examples described above with reference to FIGS. 1 to 13 may apply to the ECU 1410 described with reference to FIG. 14.

The electronic device, processors, memory, vehicle, electronic devices, systems, system 100, electronic device 110, key text graph generating device 120, management device 130, processor 1110, memory 1120, camera 1130, vehicle 1400, ECUI 1410, and sensor 1420 described herein and disclosed herein described with respect to FIGS. 1-14 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-14 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROM, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
detecting pieces of text from an image;
determining vanishing points of the image; and
estimating an orientation of the image based on the determined vanishing points, the detected pieces of text, and a key text graph representing a connection between nodes corresponding to pieces of key text.

2. The method of claim 1, wherein the estimating of the orientation comprises:
generating, among the nodes of the key text graph, a first matrix based on a first vector between nodes corresponding to the detected pieces of text;
generating a second matrix based on a second vector between the detected pieces of text in a camera coordinate system; and
calculating the orientation of the image based on the first matrix and the second matrix.

3. The method of claim 2, wherein the generating of the first matrix comprises:
determining a vector that is perpendicular to both the first vector and a selected directional vector of plural directional vectors of the key text graph; and
generating the first matrix using the first vector, the determined vector, and the selected one.

4. The method of claim 3, wherein the first vector, the determined vector, and the selected directional vector correspond to columns of the first matrix, respectively.

5. The method of claim 2, wherein the generating of the second matrix comprises:
determining coefficients of directional vectors of the key text graph to configure the first vector with a combination of the directional vectors of the key text graph;
determining an order of each of vanishing directional vectors with respect to the determined vanishing points based on the determined coefficients and a vanishing point satisfying a set reference among the determined vanishing points;
generating the second vector based on vanishing directional vectors according to the determined order and the determined coefficients;
determining a vector perpendicular to the second vector and a selected vanishing vector of the vanishing directional vectors; and
generating the second matrix using the second vector, the determined vector, and the selected vanishing vector.

6. The method of claim 5, wherein the generated second vector, the determined vector, and the selected vanishing vector correspond to columns of the second matrix, respectively.

7. The method of claim 5, wherein the determining of the order of each of the vanishing directional vectors comprises:
forming a line on the image using the detected pieces of text;
finding a vanishing point closest to the formed line among the determined vanishing points;
determining an order of vanishing directional vectors with respect to the found vanishing point according to an order of a directional vector having a coefficient with a maximum value among the determined coefficients; and
determining an order of each of remaining vanishing directional vectors according to a set reference.

8. The method of claim 2, wherein the estimating of the orientation of the image comprises:
generating a rotation matrix with respect to a transformation between a first coordinate system corresponding to the first matrix and a second coordinate system corresponding to the second matrix, using the first matrix and the second matrix; and
determining the generated rotation matrix to be the orientation of the image.

9. The method of claim 1, further comprising generating the key text graph, wherein the generating of the key text graph comprises:
determining the nodes based on pieces of key text obtained from a plurality of images obtained by capturing an inside of a space and a three-dimensional (3D) feature map of the space;
connecting each of the determined nodes to one or more adjacent nodes of each of the determined nodes to generate a plurality of edges;
classifying the generated plurality of edges into two orthogonal directions to define two dominant directions; and
connecting the determined nodes according to the two dominant directions.

10. The method of claim 9, wherein the key text graph comprises directional vectors, including a first directional vector corresponding to a first of the two orthogonal directions, a second directional vector corresponding to a second of the two orthogonal directions, and a third directional vector perpendicular to the first directional vector and the second directional vector.

11. An electronic device, comprising:
a processor configured to execute instructions; and
a memory storing the instructions, wherein execution of the instructions causes the processor to:
detect pieces of text from an image;
determine vanishing points of the image; and
determine an orientation of the image based on the determined vanishing points, the detected pieces of text, and a key text graph representing a connection between nodes corresponding to pieces of key text.

12. The electronic device of claim 11, wherein execution of the instructions causes the processor to:
generate, among the nodes of the key text graph, a first matrix based on a first vector between nodes corresponding to the detected pieces of text;
generate a second matrix based on a second vector between the detected pieces of text in a camera coordinate system; and
determine the orientation of the image based on the first matrix and the second matrix.

13. The electronic device of claim 12, wherein execution of the instructions causes the processor to:
determine a vector that is perpendicular to both the first vector and a selected directional vector of plural directional vectors of the key text graph; and
generate the first matrix using the first vector, the determined vector, and the selected directional vector.

14. The electronic device of claim 13, wherein the first vector, the determined vector, and the selected directional vector correspond to columns of the first matrix, respectively.

15. The electronic device of claim 12, wherein execution of the instructions causes the processor to:
determine coefficients of directional vectors of the key text graph to configure the first vector with a combination of the directional vectors of the key text graph;
determine an order of each of vanishing directional vectors with respect to the determined vanishing points based on the determined coefficients and a vanishing point satisfying a set reference among the determined vanishing points;
generate the second vector based on vanishing directional vectors according to the determined order and the determined coefficients;
determine a vector perpendicular to the second vector and a selected vanishing vector of the vanishing directional vectors; and
generate the second matrix using the second vector, the determined vector, and the selected vanishing vector.

16. The electronic device of claim 15, wherein the second vector, the determined vector, and the selected vanishing vector correspond to columns of the second matrix, respectively.

17. The electronic device of claim 15, wherein execution of the instructions causes the processor to:
form a line on the image using the detected pieces of text;
find a vanishing point closest to the formed line among the determined vanishing points;
determine an order of vanishing directional vectors with respect to the found vanishing point according to an order of a directional vector having a coefficient with a maximum value among the determined coefficients; and
determine an order of each of remaining vanishing directional vectors according to a set reference.

18. The electronic device of claim 12, wherein execution of the instructions causes the processor to:
generate a rotation matrix with respect to a transformation between a first coordinate system corresponding to the first matrix and a second coordinate system corresponding to the second matrix, using the first matrix and the second matrix; and
determine the generated rotation matrix to be the orientation of the image.

19. The electronic device of claim 11, wherein execution of the instructions causes the processor to generate the key text graph, the generating comprising:
determining the nodes based on pieces of key text obtained from a plurality of images obtained by capturing an inside of a space and a three-dimensional (3D) feature map of the space;
connecting each of the determined nodes to one or more adjacent nodes of each of the determined nodes to generate a plurality of edges;
classifying the generated plurality of edges into two orthogonal directions to define two dominant directions; and
connecting the determined nodes according the two dominant directions.

20. The electronic device of claim 19, wherein the key text graph comprises directional vectors, including a first directional vector corresponding to a first of the two orthogonal directions, a second directional vector corresponding to a second of the two orthogonal directions, and a third directional vector perpendicular to the first directional vector and the second directional vector.
